(19) United States
(12) Patent Application Publication
(10) Pub. No.: US 2025/0390175 A1
(43) Pub. Date: Dec. 25, 2025

(54) SYSTEM AND METHOD FOR PROVIDING THERMAL HAPTIC FEEDBACK IN A VIRTUAL OR AUGMENTED REALITY

(71) Applicant: Vanderbilt University, Nashville, TN (US)

(72) Inventors: Nilanjan Sarkar, Nashville, TN (US); Alexandra Cadence Watkins, Nashville, TN (US); Ritam Ghosh, Nashville, TN (US)

(21) Appl. No.: 19/246,456

(22) Filed: Jun. 23, 2025

Related U.S. Application Data
(60) Provisional application No. 63/663,148, filed on Jun. 23, 2024.

(51) Int. Cl. G06F 3/01

(52) U.S. Cl. CPC G06F 3/016

(57) ABSTRACT

Methods and systems for providing thermal haptic feedback in a virtual or augmented reality using a wearable device comprising a grid of thermoelectric modules. An example method includes obtaining virtual environment data describing a virtual object and material properties of the virtual object, obtaining real-world thermal input data from a real-world environment, calculating a temperature profile for the virtual object by simulating heat conduction using a plurality of contact points and the material properties, wherein the plurality of contact points are identified based on the virtual environment data, processing the real-world thermal input data and the temperature profile to assign temperature setpoints to one or more thermoelectric modules in the grid of thermoelectric modules, and generating thermal sensations by actuating the one or more thermoelectric modules.

### CROSS-REFERENCE TO RELATED APPLICATIONS

This application is a non-provisional of and claims the benefit of U.S. Provisional Patent Application No. 63/663,148, filed on Jun. 23, 2024, the entire contents of which are incorporated herein by reference.

### FIELD OF THE DISCLOSURE

Various example embodiments relate to Mixed Reality/Augmented Reality (MR/AR), and, more specifically but not exclusively, to providing thermal haptic feedback in the MR/AR environments.

### BACKGROUND

Haptic feedback plays an important role in realistically portraying a simulated environment in Virtual Reality (VR) and Mixed/Augmented Reality (MR/AR). By emulating a user's sense of touch, virtual object interactions can mimic real object interactions in a manner that provides an immersive and rewarding experience as the user learns about their environment. While tactile and kinesthetic feedback quickly come to mind when discussing haptics, an often-overlooked aspect of haptic feedback is the presentation of thermal cues to the user. Thermal sensations on contact with a virtual object allow the user to infer material properties, and if a virtual object provides the same thermal response as its real counterpart, it is more easily perceived as being present within a user's environment. Thermoreceptors in the skin are sensitive to both differences in absolute temperature and in the rate of temperature change of the skin, and research has shown that by emulating the temperature response rates of common materials in contact with skin, users can distinguish between materials in virtual reality. Beyond object interactions, the inclusion of thermal sensations as directional cues or to augment the transition between environments has been shown to provide stronger feelings of immersion and presence.

### SUMMARY

Some examples of the present disclosure provide a method for creating realistic thermal perception of virtual objects in virtual and augmented reality environments using a wearable device that delivers spatially-distributed thermal feedback to the user's palm. The device comprises a grid of individually controllable thermoelectric modules that operate in a manner that preserves hand dexterity, enabling users to interact with both physical and virtual objects within the mixed reality workspace while experiencing authentic thermal sensations corresponding to material properties of virtual objects.

Practical applications according to embodiments of the present disclosure include realistic rendering of thermal sensations to the palm. Some traditional methods do not focus on portraying a realistic and arbitrary heat distribution during contact with an object. By having a controllable grid, an arbitrary heat distribution can be emulated.

Practical applications according to embodiments of the present disclosure include differentiation between material thermal properties. Embodiments of the present disclosure provide the ability to distinguish between surfaces of different materials, such as touching a wooden versus metal table.

Practical applications according to embodiments of the present disclosure include addressing the lack of wearable, portable thermal feedback devices. Most thermal feedback devices are large and bulky, precluding them from being usable in augmented reality scenarios.

Embodiments of the present disclosure provide discrete actuators for spatial thermal rendering. Instead of having a single large source of heat/cold, embodiments use a grid of small thermoelectric devices to provide an arbitrary thermal distribution across the device.

Embodiments of the present disclosure provide a process of identifying contact surfaces and simulating heat transfer to determine the temperature setpoints of the thermoelectric array. In order to provide realistic thermal feedback, embodiments include a method of simulating heat conduction through the hand and virtual objects where points of contact are identified, heat conduction is simulated, and temperature profiles are calculated.

Embodiments of the present disclosure provide an array of temperature sensors that allows the wearer to perceive the contact temperatures of objects and surfaces in their environment even while wearing the device, which by default occludes the palm from touching physical objects in the environment. The temperature sensors are mapped one-to-one to the thermoelectric actuator in the same position on the opposite side of the device. When contact with an object is detected, the paired thermoelectric actuator mimics the temperature sensed by its temperature sensor.

According to examples of the present disclosure, a method for providing thermal haptic feedback in a virtual or augmented reality using a wearable device comprising a grid of thermoelectric modules is described. The method comprises: obtaining virtual environment data describing a virtual object and material properties of the virtual object; obtaining real-world thermal input data from a real-world environment; calculating a temperature profile for the virtual object by simulating heat conduction using a plurality of contact points and the material properties, wherein the plurality of contact points are identified based on the virtual environment data; processing the real-world thermal input data and the temperature profile to assign temperature setpoints to one or more thermoelectric modules in the grid of thermoelectric modules; and generating thermal sensations by actuating the one or more thermoelectric modules.

According to examples of the present disclosure, a thermal haptic feedback system for virtual or augmented reality applications comprises: a wearable device comprising a grid of thermoelectric modules; a virtual environment interface configured to obtain virtual environment data describing a virtual object and material properties of the virtual object; one or more thermal sensors configured to obtain real-world thermal input data from a real-world environment; a processing unit configured to: calculate a temperature profile for the virtual object by simulating heat conduction using a plurality of contact points and the material properties, wherein the plurality of contact points are identified based on the virtual environment data; and process the real-world thermal input data and the temperature profile to assign temperature setpoints to one or more thermoelectric modules in the grid; and a thermal control unit configured to generate thermal sensations by actuating the one or more thermoelectric modules according to the assigned temperature setpoints.

According to examples of the present disclosure, an apparatus for simulating thermal haptic feedback in a virtual or augmented reality environment comprises: an electronic processor; and a memory storing instructions, the instructions when executed by the electronic processor, cause the apparatus to: obtain virtual environment data describing a virtual object and material properties of the virtual object; obtain real-world thermal input data from a real-world environment; calculate a temperature profile for the virtual object by simulating heat conduction using a plurality of contact points and the material properties, wherein the plurality of contact points are identified based on the virtual environment data; process the real-world thermal input data and the temperature profile to assign temperature setpoints to one or more thermoelectric modules in the grid of thermoelectric modules; and generate thermal sensations by actuating the one or more thermoelectric modules.

### BRIEF DESCRIPTION OF THE DRAWINGS

Other aspects, features, and benefits of various disclosed embodiments will become more fully apparent, by way of example, from the following detailed description and the accompanying drawings, in which:

FIG. 1 illustrates a thermal haptic feedback system according to some examples.

FIG. 2 illustrates a thermoelectric device structure according to some examples.

FIG. 3 illustrates a control architecture according to some examples.

FIG. 4 illustrates a water cooling system according to some examples.

FIG. 5 illustrates a method for providing thermal haptic feedback in a virtual or augmented reality environment according to some examples.

FIG. 6 illustrates a wearable computing device for providing thermal haptic feedback in a virtual or augmented reality according to some examples.

FIG. 7 illustrates experimental results according to some examples.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

Some examples of the present disclosure provide a method for creating realistic thermal perception of virtual objects in virtual and augmented reality environments using a wearable device that delivers spatially-distributed thermal feedback to the user's palm. The device comprises a grid of individually controllable thermoelectric modules that operate in a manner that preserves hand dexterity, enabling users to interact with both physical and virtual objects within the mixed reality workspace while experiencing authentic thermal sensations corresponding to material properties of virtual objects.

Haptic feedback plays an important role in realistically portraying a simulated environment in Virtual Reality (VR) and Mixed/Augmented Reality (MR/AR). By emulating a user's sense of touch, virtual object interactions can mimic real object interactions in a manner that provides an immersive and rewarding experience as the user learns about their environment. While tactile and kinesthetic feedback quickly come to mind when discussing haptics, an often-overlooked aspect of haptic feedback is the presentation of thermal cues to the user. Thermal sensations on contact with a virtual object allow the user to infer material properties, and if a virtual object provides the same thermal response as its real counterpart, it is more easily perceived as being present within a user's environment. Thermoreceptors in the skin are sensitive to both differences in absolute temperature and in the rate of temperature change of the skin, and research has shown that by emulating the temperature response rates of common materials in contact with skin, users can distinguish between materials in virtual reality. Beyond object interactions, the inclusion of thermal sensations as directional cues or to augment the transition between environments has been shown to provide stronger feelings of immersion and presence.

Some devices developed for research or consumer use focus on the combination of thermal feedback with tactile sensations, and can take the form of a wearable device, such as an instrumented glove. Commercial products provide multi-modal feedback, using microfluid channels to display changes in temperature. Focus is often given to providing sensations to the fingers, either by a wearable ring or by direct stimulation of the finger pads. Thermal feedback can also be incorporated into virtual reality controllers, providing thermal cues on locations in contact with the user's hand.

As with other forms of haptic feedback, current methods mainly target VR applications, which can impart unnecessary constraints for MR/AR interactions. In order to present thermal sensations, contact with the user's skin is often necessary, which inhibits contact with real objects in the environment. This restriction on interacting with both real and virtual objects is impractical when operating within an augmented workspace. Current efforts in localized thermal feedback often target the finger pads, further reducing a user's dexterity in handling real objects. Graspable controllers eliminate the user's ability to manipulate real objects, restricting their use to virtual reality. User mobility is not as restricted as it is when incorporating force feedback, as there is no need for grounding the device or controller to account for interaction forces, meaning that the user is more able to freely move about their environment. That said, mobility can be restricted when introducing contactless forms of thermal feedback, such as the use of infrared lamps or chilled air, as the thermal rendering workspace cannot move with the user.

In some examples, like tactile and force feedback applications, a practical solution to meeting the needs of MR/AR environments is to apply thermal feedback on a different location than the actual point of contact. Isolating feedback to the base of the finger has been shown to be viable, as well as completely relocating stimuli to the user's wrist. A prime candidate for a relocation target is the palm of the hand, as it is still near contact surfaces of the fingers, can be a direct point of contact with virtual objects itself, and provides a relatively large surface area in which to render thermal sensations. Recent work has investigated the sensitivity of the palm and shown that it is sufficient for thermal cues. Considering not only the intensity of thermal feedback but also the shape or pattern of the presented stimulus is often overlooked. The vast majority of applications apply thermal sensations to a single area. Multi-source thermal feedback has been used but is mainly relegated to directional cues or extending the area of applied sensation.

In some examples, thermal information is sensed through free nerve endings embedded within the skin called thermoreceptors that respond to changes in skin temperature. Thermoreceptors are used in two distinct systems: a thermoreceptor network for cold sensations, and a network for warm sensations. The skin has a higher density of cold thermoreceptors, providing a higher level of sensitivity to cold sensations. Sensitivity for both warm and cold sensations vary across the body. Thermoreceptors react not only to temperature differences but to the rates of temperature change. The reaction time to cold sensations for a temperature drop of greater than 0.1° C./sec is 0.3-0.5 seconds, while the reaction time to warm sensations for a rise greater than 0.1° C./sec is 0.5-0.9 seconds. This is an important fact for the design of thermal feedback systems, as the minimum response time for believable feedback is much longer than that of other forms of haptic feedback. Cold thermoreceptors show highest activation levels around 25° C., with a constant cold sensation after going below 20° C., while warm thermoreceptors peak at around 45° C., with temperatures beyond these thresholds beginning to activate the skin's pain receptors, moving to full pain activation below 3° C. and above 48° C. In addition to alerting to surface contact, a thermoreceptor network's sensitivity to rates of temperature change plays a large role in identifying and differentiating between materials. Average skin temperature ranges from 30° C.-36° C., which is important to consider as the temperature differential aspect of thermoreceptor sensing means that the same thermal input can be perceived differently based on initial skin temperature.

According to one embodiment of the present disclosure, a wearable array of thermal actuators situated on the palm can effectively make use of the functionality and sensitivity of the body's warm and cold thermoreceptor networks to elicit accurate and authentic thermal discrimination. In some examples, the array comprises thermoelectric modules to provide meaningful feedback that incorporates the thermal response times observed for both warm and cold sensations and considers the temperature range in which each type of thermoreceptor is activated. A successful device accounts for temperature thresholds that may induce pain and accommodates the variable nature of skin temperature that contributes to the perception of thermal stimuli. It is important to ensure that the thermal device does not impact the user's ability to sense temperature. The Just Noticeable Difference (JND) associated with the device can be measured to verify this capability. The JND is the minimum difference in magnitude between a reference stimulus and a test stimulus that can be detected by a human with a given reliability.

The JND associated with the device can be measured to verify this capability. The JND may refer to the minimum difference in magnitude between a reference stimulus and a test stimulus that can be detected by a human with a given reliability. In the context of thermal feedback, JND represents the smallest temperature difference between two thermal stimuli that is noticeable by a user with a specified level of accuracy, such as 75% correct detection rate. A lower JND value indicates that users can detect smaller temperature differences, demonstrating higher sensitivity and better device performance for thermal discrimination tasks.

According to some examples, thermal sensations may contribute to enhancing the tactile experiences, for example in discerning spatial patterns, also known as “spatial icons” and cues. Some examples have focused on the design of thermal sensation displays. These displays have been adapted for wearable devices, such as skin-like, highly stretchable thermal actuators. Previous work has been done in stationary multi-point thermal displays. Some example developments include thermal displays for the fingertip that involve thermal actuators on either side of the finger to elicit a perceived thermal response on the finger pad itself. Other example developments include thermal displays composed of a set of heating actuators and a single thermoelectric module for cooling. More recently, wearable arrays of thermoelectric actuators have been developed for use in hand rehabilitation applications.

According to some examples, abstract information can also be conveyed through spatial thermal cues, allowing for the extension of user interfaces into the haptic domain, meaning that virtual and mixed reality applications no longer have to rely on purely visual cues for presenting information to users or prompting them for information. For example, some systems combine vibro-tactile elements and multiple thermoelectric modules to allow multi-modal feedback. A more complex application of an array of thermal actuators is seen in systems where two-dimensional arrays of thermoelectric modules are integrated into assistive devices.

According to some examples, a wearable device comprising an array of thermal actuators is capable of presenting spatial cues to the user through the use of a set of thermal icons. In some examples, experiments can be conducted to validate this capability, where participants are asked to discriminate between pairs of presented thermal icons.

Accurately rendering moving thermal sensations is another technical challenge that, once met, provides enhanced immersion in mixed reality spaces. Often users do not simply make static contact to virtual objects but move their hands along surfaces. Additionally, objects within a workspace are not guaranteed to be static but can be actively moving or interacting with the user. For example, a virtual avatar representing a remote user can shake hands with the local user or move their virtual hands along the arm of the real user.

According to some examples, methods for rendering moving thermal sensations are explored by for example, utilizing the phenomenon of thermal referral, where a static thermal sensation is perceived to be located at the same point as a nearby vibrotactile sensation. Some example systems make use of this haptic illusion by overlaying a static thermal source on top of a moving tactile sensation to give the illusion of movement of both the tactile and thermal stimuli.

Some other example systems develop wearable vests that combine vibrotactile and thermal actuators to elicit moving thermal sensations in VR. These devices both make use of multi-modal feedback to generate the moving sensation, with a high-resolution grid of vibrotactile actuators and a low-resolution grid, or even single point, of thermal actuators.

In some examples, thermal actuators are utilized, wherein a spatial-temporal thermal sensation is rendered and presents the illusion of movement. This approach extends the observed illusion of moving tactile stimuli, where a tightly spaced tactile display can be triggered with an onset delay between individual actuators to create a moving sensation. By staggering the presentation of a thermal stimulus along a line of actuators, users can interpret the sensation as a single thermal source that is moving along the grid.

According to some embodiments of the present disclosure, a perception of movement can be conveyed to the wearer of the wearable thermal device by altering the spatial-temporal patterns presented to the palm. In some examples, experiments integrating the device within an MR/AR experience can be conducted wherein qualitative data on use experience and the perceived realism of thermal movement is collected to validate this capability.

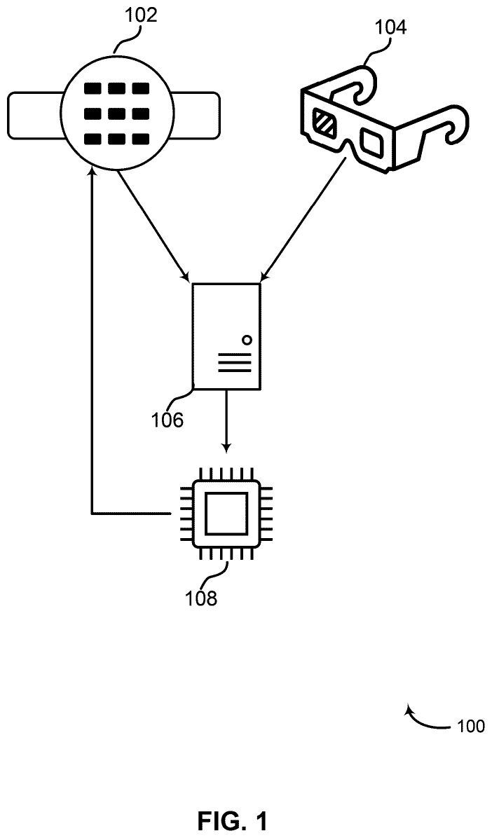

FIG. 1 illustrates a thermal haptic feedback system 100 according to some examples. FIG. 1 provides a system overview diagram showing the high-level components of the thermal haptic feedback system 100. The thermal haptic feedback system 100 includes a thermal feedback device 102, virtual environment interface 104, processing unit 106, and thermal control unit 108, and their interconnections.

Referring to FIG. 1, the thermal haptic feedback system 100 comprises a thermal feedback device 102, a virtual environment interface 104, a processing unit 106, and a thermal control unit 108. In the example shown in FIG. 1, the thermal feedback device 102 includes an array of thermoelectric modules arranged in a grid (e.g., 3×3). However, embodiments of the present disclosure are not limited thereto.

In this example, each thermoelectric module may function as an individual heat pump capable of either drawing heat away from or pumping heat into its immediate vicinity, thus providing spatially precise and dynamically adjustable thermal patterns across the surface of the thermal feedback device 102.

The array of thermoelectric modules within the thermal feedback device 102 may create heat flux across the junction of two dissimilar materials. When a DC electric current flows through a thermoelectric module, a temperature differential arises across the module as heat is transferred from one side to another, creating a “hot” side and a “cold” side. The direction of heat flow is reversible by changing direction of current flow through the thermoelectric module, meaning that a single contact surface can be used for both heating and cooling an object. Convention designates the temperature-controlled surface as the “cold” side, with the “hot” side being used for thermal management.

Heat absorption on the “cold” side of the thermoelectric module (qₚₑₗ) is a function of component materials, current temperature (Tc) and applied current (I):

$${q}_{pel} = - α {q}_{c} q \qquad ( 1 )$$

where α is the Seebeck coefficient of the thermoelectric module, encompassing material properties, and the negative sign represents heat flow out of the “cold” side. This heat absorption is impeded by natural heat conduction back to the “cold” side due to the temperature differential, and waste heat generated due to the thermoelectric module's internal resistance and applied current.

Actual heat flow out of the “cold” side is described by:

$${Q}_{c} = - α {T}_{c} g + \frac{1}{{R}_{th}} ( {T}_{h} - {T}_{c} ) + \frac{1}{2} {R}_{el} {l}^{2} \qquad ( 2 )$$

where Rₜₕ and Rₑₗ represent the thermoelectric module's thermal and electrical resistances, respectively.

In some examples, half of the electrical heat generated,

$$\frac{1}{2} {R}_{el} {l}^{2} ,$$

is included, as waste heat is assumed to be dumped equally on both sides of the module. The thermal conduction and waste heat terms have an important ramification: as the temperature differential across the thermoelectric module rises, a decreasing amount of heat is effectively moved, and the module becomes less efficient. A maximum AT can be generated across the thermoelectric module where natural heat conduction and waste heat generation completely negate the heat flow induced by the thermoelectric effect. If the “hot” side of the thermoelectric module is held near ambient conditions using a heat sink or thermal management solution, this maximum temperature differential describes the bounds of simulated thermal sensations that can be applied to the skin contacting the thermal feedback device 102.

In some examples, the thermoelectric modules are encapsulated within a flexible silicone base, selected for its excellent mechanical flexibility and biocompatibility. The silicone base is not merely a passive container but incorporates water-cooling channels designed to efficiently disperse heat away from the thermoelectric modules during heavy or sustained operation, preventing potentially damaging thermal buildup.

The incorporation of the wearable silicone base provides several utilitarian benefits for use in mixed reality and augmented reality applications. The wearable nature of the thermal feedback device 102 enables mobility, as the flexibility and lightness of the silicone material allows the thermal feedback device 102 to be worn unobtrusively on the palm while the user moves within their environment. By snugly fitting into the user's palm, the flexible nature of the thermal feedback device 102 allows the array to contour to the unique topography of each user's palm, optimizing contact area and promoting efficient heat transfer. This contouring effect is enhanced by securely strapping the thermal feedback device 102 to the hand, applying significant contact pressure and reducing the likelihood of positional slippage during movement.

The processing unit 106 controls the thermal feedback device 102 through a custom printed circuit board utilizing off-the-shelf thermoelectric module drivers. The drivers control the current passing through each thermoelectric module, modulating the thermal effects based on input from the processing unit 106.

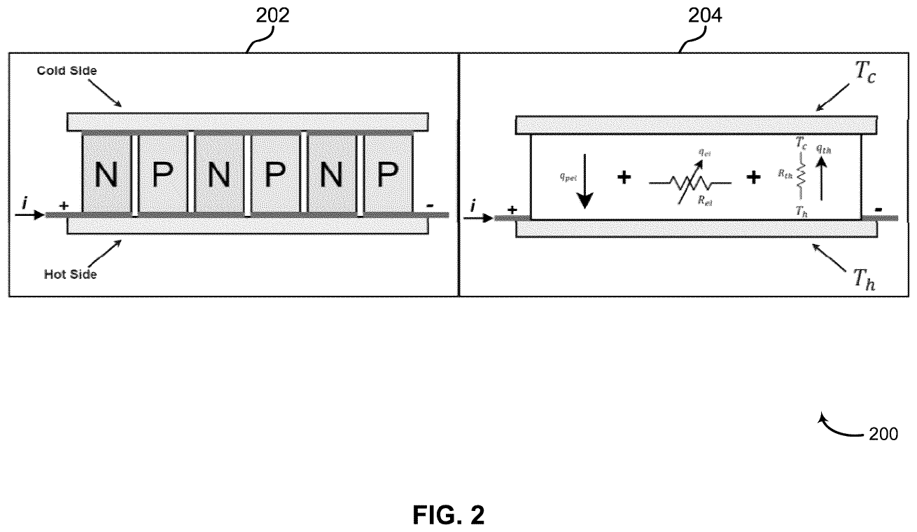

FIG. 2 is a detailed structural diagram illustrating the thermoelectric device structure 200 and its thermal operation principles, showing both the physical semiconductor arrangement and the equivalent thermal circuit model.

While FIG. 1 illustrates the overall system architecture, the detailed structure and operation of the thermoelectric modules within the thermal feedback device 102 is described with reference to FIG. 2.

Referring to FIG. 2, the thermoelectric device structure 200 comprises a thermoelectric module 202 and an equivalent thermal circuit model 204. The thermoelectric module 202 is made from alternating n-type and p-type semiconductors placed in series electrically but in parallel thermally. When a DC current is passed through the semiconductors, a hot side and cold side develop. The equivalent thermal circuit model 204 illustrates that this temperature differential is due to heat flow from the Peltier effect (qₚₑₗ) and is resisted by electrical waste heat generation (qₑₗ) and natural heat conduction (qₜₕ).

In some examples, considerations are given to the control hardware used with thermoelectric modules. Voltage regulation using an H-Bridge circuit controlled with pulse-width modulation (PWM) has a negative impact on the thermoelectric module's efficiency due to excessive waste heat generation. As described in equation (2), this is because the waste heat generated scales quadratically with applied current while thermoelectric heat flux is only linearly proportional to current. A PWM controller works by rapidly switching between a constant DC voltage and a grounded input. This method works well for loads with an inductive component, such as a motor, as the resulting current across the load is effectively steady and scales with the PWM's duty cycle. A thermoelectric module is a resistive load, meaning that the induced current rapidly switches between a maximum value and zero amperes, amplifying the waste heat losses. Examples of the present disclosure thus provide a solution including filtering the thermoelectric module's power source to generate a variable DC voltage supply with minimal ripple voltage. This solution may be implemented using a differential filter or a class D amplifier. In some examples, the solution may be achieved by utilizing off-the-shelf thermoelectric module drivers and additional passive components to complete the filtering circuit.

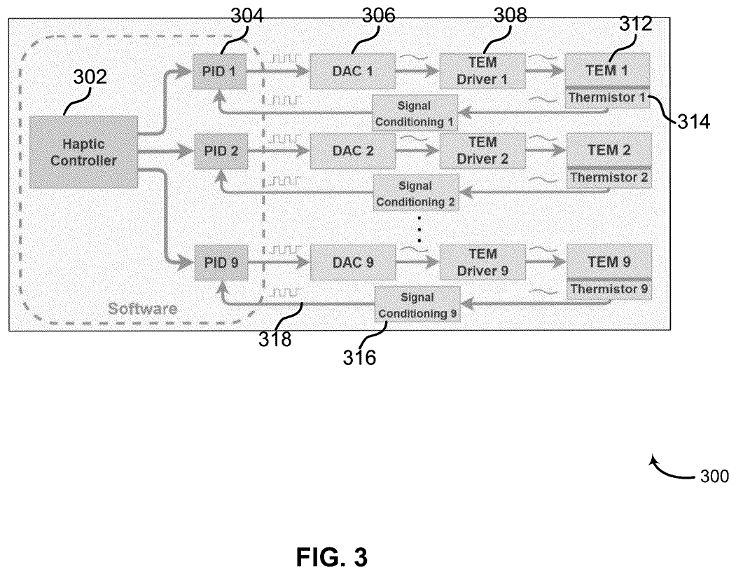

FIG. 3 illustrates a detailed control architecture 300 depicting an electronic control system that implements the thermal control functionality of the thermal control unit 108 shown in FIG. 1.

Referring to FIG. 3, the control architecture 300 comprises a haptic controller 302, multiple PID controllers 304, digital-to-analog converters (DACs) 306, thermoelectric module drivers 308, thermoelectric modules (TEMs) 312, thermistors 314, signal conditioning circuits 316, and feedback loops 318. The thermal display control loop developed consists of a software PID controller 304, the ADN8833 thermoelectric module driver 308, a differential filter 310 with a cutoff frequency of 5 kHz, and a thermistor 314 mounted on the thermoelectric module's cold side for temperature feedback. While the drive circuit, a filter, and temperature sensor are separate channels and contain corresponding hardware for each thermoelectric module 312, a single microcontroller within the haptic controller 302 is sufficient to run all the PID controllers 304 and interface with the processing unit 106 to receive thermal rendering input.

The PID control signals are generated using the haptic controller 302 and sent to the digital-to-analog converters 306 to generate the control voltages necessary to drive each thermoelectric module 312. The thermistor readings are sent through the signal conditioning circuits 316 and read by the haptic controller 302 through the feedback loops 318 to close the control loop. Additional components of the control architecture 300 include separate multiplexers for the thermistor readings, thermoelectric module current sense, and thermoelectric module voltage sense, allowing each to be read by the haptic controller 302 using a single input pin each.

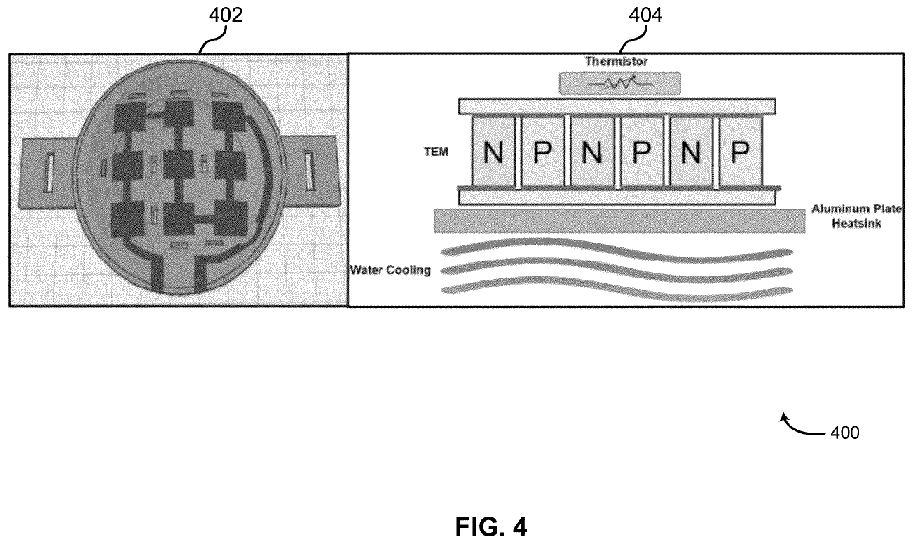

FIG. 4 illustrates a water cooling system 400 according to some examples. The water cooling system 400 is an implementation of the thermal management system within the thermal feedback device 102.

A thermoelectric module acts as a resistive load and leads to a large amount of excess heat generation. The resistive heating dumped on the cold side (12R) may approach Qₘₐₓ, the maximum heat transfer capable by the thermoelectric module. Additionally, as described in equation (2), when in cooling mode natural thermal conduction within the thermoelectric module transfers heat from the hot side to the cold side. If not addressed, this heat buildup will quickly counter any attempts to lower the temperature of the thermoelectric module's cold side.

To address this issue, referring to FIG. 4, the water cooling system 400 is implemented comprising water cooling channels 402 and thermoelectric module assemblies 404. The water cooling solution is built into the flexible and wearable silicone base itself, allowing for water cooling to be applied while still maintaining the mobile benefits of the wearable thermal feedback device 102. As shown in the water cooling channels 402, each thermoelectric module assembly 404 is water cooled in series, allowing for steady volumetric flow across each thermoelectric module.

In this example, each thermoelectric module assembly 404 includes a thermistor, the thermoelectric module itself, an aluminum plate acting as an intermediary heat sink, and then contact with the water cooling channels 402 underneath. When implementing the water cooling solution, the maximum total energy transfer that the water cooling system 400 would need to handle is determined. For example, the maximum necessary heat dissipation occurs when the thermoelectric module is in cooling mode, meaning the cold side is reduced in temperature and the hot side is increased in temperature. Flipping the signs of the qₚₑₗ and thermal conduction components in equation (2), heat flow into the hot side is described by:

$${Q}_{h} = α {T}_{c} Z + \frac{1}{{R}_{tu}} ( {T}_{c} - {T}_{h} ) + \frac{1}{2} {R}_{el} {I}^{2} \qquad ( 3 )$$

In some examples, it is assumed that T_{c}=Tₕ, and the thermal conduction component goes away. The first component, representing qₚₑₗ, can be set as the Qₘₐₓ value of the specific thermoelectric module used. As there are nine total thermoelectric modules in the assembly, Qₘₐₓ for the entire array can be calculated as:

$${Q}_{{max}_{Array}} = 9 * ( 1.7 + \frac{1}{2} 4.17 * {0.7}^{2} ) = 24.49 W \qquad ( 4 )$$

The maximum temperature rise for the water in the water cooling system 400 can be described by:

$$Δ T = \frac{{Q}_{{max}_{Array}}}{ρ Vc} \qquad ( 5 )$$

where ρ is the density of water (1000 kg/m³), V is the volumetric flowrate (measured to be 2.25 ml/s), and c is the specific heat of water (4182 J/kg·K). Plugging these values in, the maximum temperature differential is:

$$Δ T = \frac{24.49}{1000 * 2.25 {e}^{- 6} * 4184} = 2.6 K \qquad ( 6 )$$

The intermittent use of the thermoelectric modules, combined with relatively small AT for the water and the relatively large size of the water reservoir, leads to the conclusion that the water cooling system 400 remains stable even with prolonged use of the thermal feedback device 102.

A heating element within the water reservoir keeps the water temperature at 30° C., which is within the range of skin temperature of 25° C.-36° C. Due to the large size of the water cooling channels 402 compared to the size of the thermal feedback device 102, and the thermal properties of the silicone material with which it was made, this maintains a steady temperature of 30° C. for the entire thermal feedback device 102. Maintaining the thermal feedback device 102 at skin temperature is of great importance for multiple reasons. First and foremost, doing so establishes a neutral baseline, enabling the user to perceive both warming and cooling stimuli from the thermal feedback device 102. This neutral baseline also minimizes sensory adaptation, thereby preserving the sensitivity and responsiveness of the user's skin to the thermal haptic feedback. Additionally, keeping the thermal feedback device 102 at skin temperature when not actively providing thermal feedback enhances user comfort and reduces the likelihood of skin irritation or discomfort from prolonged contact with a device that is either too cold or too warm.

In some examples, a heating element within the water reservoir keeps the water temperature at 30° C., which is within the range of skin temperature of 25° C.-36° C. Due to the large size of the water cooling channels 402 compared to the size of the thermal feedback device 102, and the thermal properties of the silicone material with which it is made, this design maintains a steady temperature of 30° C. for the entire thermal feedback device 102.

Examples of the present disclosure maintain the thermal feedback device 102 at skin temperature. In some examples, maintaining the thermal feedback device 102 at skin temperature establishes a neutral baseline, enabling the user to perceive both warming and cooling stimuli from the thermal feedback device 102. The neutral baseline may also minimize sensory adaptation, thereby preserving the sensitivity and responsiveness of the user's skin to the thermal haptic feedback. In some examples, keeping the thermal feedback device 102 at skin temperature when not actively providing thermal feedback enhances user comfort and reduces the likelihood of skin irritation or discomfort from prolonged contact with a device that is either too cold or too warm.

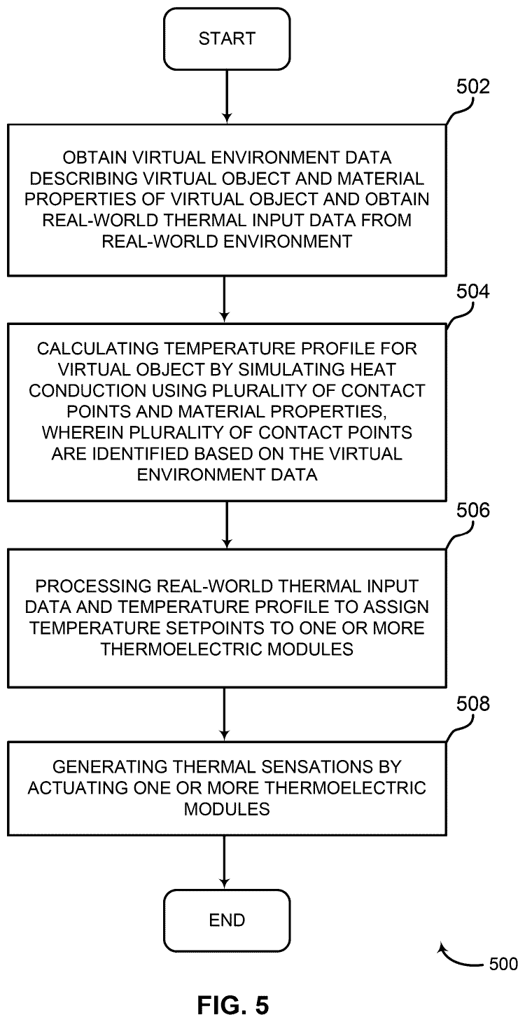

FIG. 5 illustrates a method 500 for providing thermal haptic feedback in a virtual or augmented reality environment according to some examples. The method 500 enables realistic thermal perception of virtual objects through spatially-distributed thermal feedback applied at the user's palm using a wearable device comprising a grid of thermoelectric modules.

Operations of block 502 include obtaining virtual environment data describing a virtual object and material properties of the virtual object and obtaining real-world thermal input data from a real-world environment. The virtual environment data is received through the virtual environment interface 104 shown in FIG. 1 and includes information about virtual objects present in the virtual or augmented reality environment, including their geometric properties, material characteristics, and thermal properties such as thermal conductivity, specific heat capacity, and surface temperature. The real-world thermal input data provides information about the actual thermal conditions in the user's physical environment and can be used to blend virtual thermal sensations with real-world thermal experiences.

In some examples, the real-world thermal input data is obtained from temperature sensors positioned on contact surfaces of the thermoelectric modules, and processing the real-world thermal input data comprises selectively overriding the temperature setpoints when contact with a real-world object is detected. These temperature sensors, such as thermistors 314 shown in FIG. 3, enable the thermal feedback device 102 to detect when the user is touching physical objects in their environment and can modify or override the virtual thermal feedback to allow perception of real-world thermal properties.

Operations of block 504 include calculating a temperature profile for the virtual object by simulating heat conduction using a plurality of contact points and the material properties, wherein the plurality of contact points are identified based on the virtual environment data. The processing unit 106 performs this calculation by first identifying where the user's hand, specifically the palm region covered by the thermal feedback device 102, would make contact with the virtual object based on hand tracking data and virtual object geometry. The heat conduction simulation takes into account the thermal properties of both the virtual object and the user's skin to determine realistic temperature distributions that would occur during actual physical contact.

In some examples, calculating the temperature profile comprises simulating heat transfer by determining heat absorption on a cold side of each thermoelectric module based on material properties, applied current, and temperature conditions. This simulation accounts for the thermoelectric effects, thermal conduction losses, and electrical resistance heating effects as described in equations (1) and (2), providing physically accurate thermal modeling for realistic haptic feedback.

Operations of block 506 include processing the real-world thermal input data and the temperature profile to assign temperature setpoints to one or more thermoelectric modules in the grid. This processing step performed by the processing unit 106 involves mapping the calculated temperature profile onto the spatial arrangement of thermoelectric modules within the thermal feedback device 102. The assignment considers both the virtual thermal requirements and any real-world thermal conditions that should be preserved or integrated into the thermal feedback experience.

In some examples, the grid comprises a 3×3 array of thermoelectric modules and processing the real-world thermal input data and the temperature profile comprises mapping specific contact areas of the virtual object to corresponding spatial locations in the 3×3 array. This spatial mapping allows different regions of the user's palm to experience different thermal sensations simultaneously, enabling complex thermal patterns that correspond to the shape and thermal properties of virtual objects. However, embodiments of the present disclosure are not limited to the 3×3 array of thermoelectric modules.

Operations of block 508 include generating thermal sensations on the user's palm by actuating the one or more thermoelectric modules. The thermal control unit 108 receives the temperature setpoints from the processing unit 106 and controls the individual thermoelectric modules through the control architecture 300 described with reference to FIG. 3. This actuation creates spatially-distributed thermal patterns that correspond to the thermal properties of the virtual object, providing realistic thermal haptic feedback to the user.

In some examples, generating thermal sensations comprises creating spatial-temporal thermal patterns by sequentially actuating different thermoelectric modules in the grid to simulate movement of a thermal source across the user's palm. This technique creates the illusion of a moving thermal stimulus by activating thermoelectric modules in sequence, such as when a virtual object moves across the user's hand or when simulating thermal effects that have directional components.

In some examples, the method 500 further comprises maintaining the thermoelectric modules at a baseline temperature corresponding to skin temperature using a thermal management system, wherein the temperature setpoints represent deviations from the baseline temperature. As described with reference to FIG. 4, the water cooling system 400 maintains the thermal feedback device 102 at approximately 30° C., which corresponds to normal skin temperature, providing a neutral thermal baseline from which both warming and cooling sensations can be effectively perceived.

In some examples, the wearable device is mounted on the user's palm with control hardware positioned on a back of the user's hand or forearm, and the method 500 further comprises maintaining user dexterity by allowing unrestricted finger movement during thermal feedback generation. This configuration ensures that the thermal feedback device 102 does not interfere with the user's ability to manipulate real objects in augmented reality environments or to perform natural hand gestures in virtual reality applications.

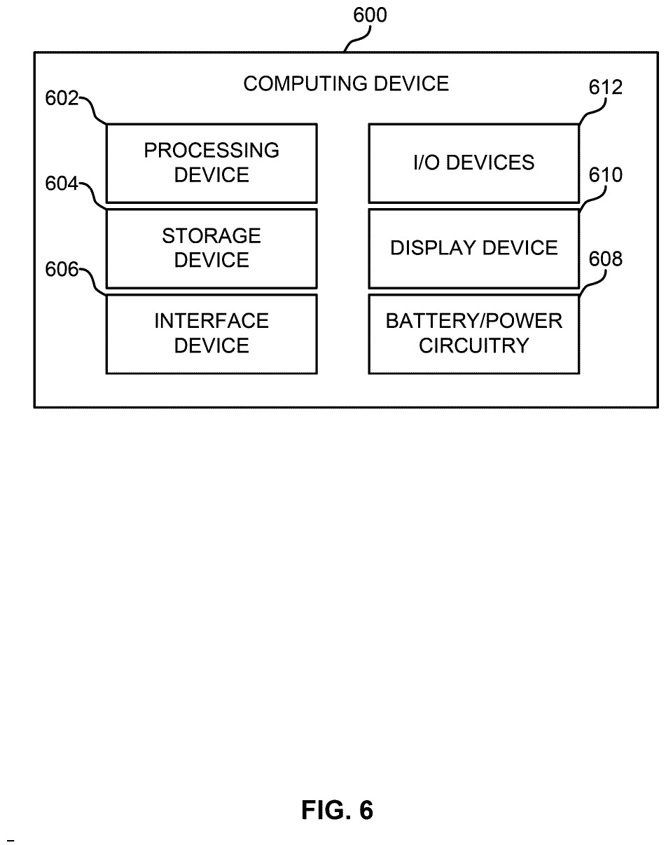

FIG. 6 illustrates a wearable computing device 600 for providing thermal haptic feedback in a virtual or augmented reality according to some examples. The wearable haptic feedback computing device 600 implements the functions and methods described in FIGS. 1-5.

The computing device 600 includes a processing device 602, a storage device 604, an interface device 606, a battery/power circuitry 608, I/O devices 610, a display device 610, and I/O devices 612.

The computing device 600 includes one or more instances of which can be used to implement at least some of the above-described methods and pipelines according to some examples. The computing device 600 is illustrated as having a number of components, but one or more of these components may be omitted or duplicated, as suitable for the application and setting. In some embodiments, some or all of the components included in the computing device 600 may be attached to one or more motherboards and enclosed in a housing. In some embodiments, some of those components may be fabricated onto a single system-on-a-chip (SoC) (e.g., the SoC may include one or more electronic processing devices 602 and one or more storage devices 604). Additionally, in various embodiments, the computing device 600 may not include one or more of the components illustrated in FIG. 6, but may include interface circuitry for coupling to the one or more components using any suitable interface (e.g., a Universal Serial Bus (USB) interface, a High-Definition

Multimedia Interface (HDMI) interface, a Controller Area Network (CAN) interface, a Serial Peripheral Interface (SPI) interface, an Ethernet interface, a wireless interface, or any other appropriate interface). For example, the computing device 600 may not include a display device 610, but may include display device interface circuitry (e.g., a connector and driver circuitry) to which an external display device 610 may be coupled.

The computing device 600 includes a processing device 602 (e.g., one or more processing devices). As used herein, the terms “electronic processor device” and “processing device” interchangeably refer to any device or portion of a device that processes electronic data from registers and/or memory to transform that electronic data into other electronic data that may be stored in registers and/or memory. In various embodiments, the processing device 602 may include one or more digital signal processors (DSPs), application-specific integrated circuits (ASICs), central processing units (CPUs), graphics processing units (GPUs), server processors, or any other suitable processing devices.

The computing device 600 also includes a storage device 604 (e.g., one or more storage devices). In various embodiments, the storage device 604 may include one or more memory devices, such as random-access memory (RAM) devices (e.g., static RAM (SRAM) devices, magnetic RAM (MRAM) devices, dynamic RAM (DRAM) devices, resistive RAM (RRAM) devices, or conductive-bridging RAM (CBRAM) devices), hard drive-based memory devices, solid-state memory devices, networked drives, cloud drives, or any combination of memory devices. In some embodiments, the storage device 604 may include memory that shares a die with the processing device 602. In such an embodiment, the memory may be used as cache memory and include embedded dynamic random-access memory (eDRAM) or spin transfer torque magnetic random-access memory (STT-MRAM), for example. In some embodiments, the storage device 604 may include non-transitory computer readable media having instructions thereon that, when executed by one or more processing devices (e.g., the processing device 602), cause the computing device 600 to perform any appropriate ones of the methods disclosed herein below or portions of such methods.

The computing device 600 further includes an interface device 606 (e.g., one or more interface devices 606). In various embodiments, the interface device 606 may include one or more communication chips, connectors, and/or other hardware and software to govern communications between the computing device 600 and other computing devices. For example, the interface device 606 may include circuitry for managing wireless communications for the transfer of data to and from the computing device 1000. The term “wireless” and its derivatives may be used to describe circuits, devices, systems, methods, techniques, communications channels, etc., that may communicate data via modulated electromagnetic radiation through a nonsolid medium. The term does not imply that the associated devices do not contain any wires, although in some embodiments they might not. Circuitry included in the interface device 606 for managing wireless communications may implement any of a number of wireless standards or protocols, including but not limited to Institute for Electrical and Electronic Engineers (IEEE) standards including Wi-Fi (IEEE 802.6 family), IEEE 802.16 standards, Long-Term Evolution (LTE) project along with any amendments, updates, and/or revisions (e.g., advanced LTE project, ultramobile broadband (UMB) project (also referred to as “3GPP2”), etc.). In some embodiments, circuitry included in the interface device 606 for managing wireless communications may operate in accordance with a Global System for Mobile Communication (GSM), General Packet Radio Service (GPRS), Universal Mobile Telecommunications System (UMTS), High Speed Packet Access (HSPA), Evolved HSPA (E-HSPA), or LTE network. In some embodiments, circuitry included in the interface device 606 for managing wireless communications may operate in accordance with Enhanced Data for GSM Evolution (EDGE), GSM EDGE Radio Access Network (GERAN), Universal Terrestrial Radio Access Network (UTRAN), or Evolved UTRAN (E-UTRAN). In some embodiments, circuitry included in the interface device 606 for managing wireless communications may operate in accordance with Code Division Multiple Access (CDMA), Time Division Multiple

Access (TDMA), Digital Enhanced Cordless Telecommunications (DECT), Evolution-Data Optimized (EV-DO), and derivatives thereof, as well as any other wireless protocols that are designated as 3G, 4G, 5G, and beyond. In some embodiments, the interface device 606 may include one or more antennas (e.g., one or more antenna arrays) configured to receive and/or transmit wireless signals.

In some embodiments, the interface device 606 may include circuitry for managing wired communications, such as electrical, optical, or any other suitable communication protocols. For example, the interface device 606 may include circuitry to support communications in accordance with Ethernet technologies. In some embodiments, the interface device 606 may support both wireless and wired communication, and/or may support multiple wired communication protocols and/or multiple wireless communication protocols. For example, a first set of circuitry of the interface device 606 may be dedicated to shorter-range wireless communications such as Wi-Fi or Bluetooth, and a second set of circuitry of the interface device 606 may be dedicated to longer-range wireless communications such as global positioning system (GPS), EDGE, GPRS, CDMA, WiMAX, LTE, EV-DO, or others. In some other embodiments, a first set of circuitry of the interface device 606 may be dedicated to wireless communications, and a second set of circuitry of the interface device 606 may be dedicated to wired communications.

The computing device 600 also includes battery/power circuitry 608. In various embodiments, the battery/power circuitry 608 may include one or more energy storage devices (e.g., batteries or capacitors) and/or circuitry for coupling components of the computing device 600 to an energy source separate from the computing device 600 (e.g., to AC line power).

The computing device 600 also includes a display device 610 (e.g., one or multiple individual display devices). In various embodiments, the display device 610 may include any visual indicators, such as a heads-up display, a computer monitor, a projector, a touchscreen display, a liquid crystal display (LCD), a light-emitting diode display, or a flat panel display.

The computing device 600 also includes additional input/output (I/O) devices 612. In various embodiments, the I/O devices 612 may include one or more data/signal transfer interfaces, audio I/O devices (e.g., microphones or microphone arrays, speakers, headsets, earbuds, alarms, etc.), audio codecs, video codecs, printers, sensors (e.g., thermocouples or other temperature sensors, humidity sensors, pressure sensors, vibration sensors, etc.), image capture devices (e.g., one or more cameras), human interface devices (e.g., keyboards, cursor control devices, such as a mouse, a stylus, a trackball, or a touchpad), etc.

Depending on the specific embodiment, various components of the interface devices 606 and/or I/O devices 612 can be configured to output suitable control signals, receive suitable control/telemetry signals, and receive and transmit data streams. In some examples, the interface devices 606 and/or I/O devices 612 include one or more analog-to-digital converters (ADCs) for transforming received analog signals into a digital form suitable for operations performed by the processing device 602 and/or the storage device 604. In some additional examples, the interface devices 606 and/or I/O devices 612 include one or more digital-to-analog converters (DACs) for transforming digital signals provided by the processing device 602 and/or the storage device 604 into an analog form suitable for being transmitted through a communication channel.

### System Performance and Experimental Validation

According to some embodiments of the present disclosure, the performance of the thermal feedback device 102 are examined. In some examples, the thermal feedback device 102 exhibits control capabilities and a robust operational temperature range spanning from 15° C. to 43° C., exceeding the bounds of human skin temperature and ensuring that thermal stimuli perceptible to users. The thermal feedback device 102 allows for individual control of each thermoelectric module, providing spatial resolution for thermal stimuli.

In some examples, investigating the dynamic performance of the thermal feedback device 102, a step input exhibited quick response for both warming and cooling modes while in contact with a human palm. A warming rise time of 1.4 seconds and a cooling rise time of 2.4 seconds were observed. The disparity in these rise times may be ascribed to the resistive heating of the thermoelectric modules, which facilitates the temperature increase in warming mode while impeding the temperature decrease in cooling mode. The thermal feedback device 102 demonstrated an ability to instigate temperature change rates exceeding 0.1° C./sec almost instantaneously, implying that the onset of thermal stimuli detectable by the user is essentially immediate.

According to some embodiments, experimental validation is conducted with human subjects to confirm the effectiveness of the thermal feedback device 102. In one example, 12 subjects participated in controlled studies designed to evaluate thermal perception capabilities and user experience enhancement.

According to some embodiments, to confirm that the thermal feedback device 102 does not interfere with the user's capacity to perceive temperature changes, the JND is quantified. JND represents the smallest discernible variation in magnitude between stimuli that a human can identify with a specific degree of reliability. For example, using the adaptive staircase method, participants were presented with reference and test stimuli for four conditions: warming/cooling the entire thermal feedback device 102, and warming/cooling a single row of the thermoelectric module array.

In this example, results showed average JNDs ranging from 2.51° C. to 3.88° C. across different conditions. The results indicated a trend that the JND is smaller for full array activation conditions, implying that users can detect smaller thresholds between stimuli when the entire thermoelectric module array is activated.

According to some embodiments, to validate spatial thermal rendering capabilities, a spatial icon discrimination task is developed. In some examples, participants were presented with thermal icons representing different spatial patterns (left, right, or middle vertical columns, or top, bottom, or middle horizontal rows of the array). Using a temperature step size of 8° C. above/below ambient, accuracy in detecting icon changes ranged from 41.7% to 100% for warm stimuli and from 50.0% to 100% for cool stimuli, with overall detection probabilities of approximately 78% for both warm and cool conditions.

According to some embodiments, the impact of spatial-temporal patterns on the perception of moving stimuli is evaluated in mixed reality and augmented reality environments. For example, an application is developed using a commercial game engine for a head-mounted augmented reality device wherein users viewed a virtual ball moving across a surface. Sequential thermoelectric modules were activated to simulate the ball's movement under the user's hand.

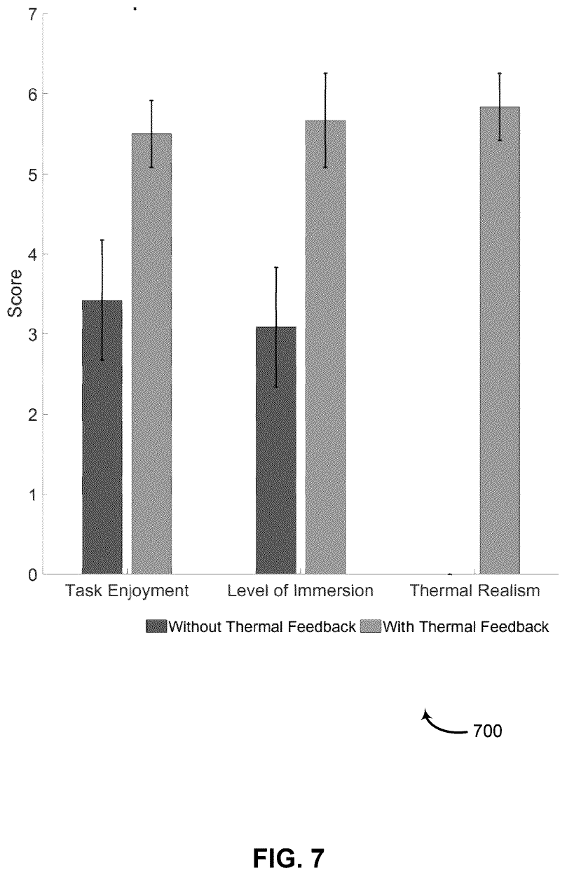

FIG. 7 illustrates experimental results 700 according to some examples. Referring to FIG. 7, the experimental results 700 demonstrate the impact of thermal feedback on user experience in virtual and augmented reality environments. The experimental results 700 show ratings for task enjoyment, level of immersion, and thermal realism across different conditions. In this example, enjoyment ratings increased from 3.42 without feedback to 5.50 with feedback, while immersion ratings increased from 3.08 to 5.67. Participants rated the realism of moving thermal sensations as 5.83, and all participants indicated a preference for thermal feedback.

Statistical analysis showed significant increases in positive feelings with thermal feedback presence, and the applied spatial-temporal patterns successfully elicited the perception of movement. The experimental results 700 validate the utility of the thermal feedback device 102 in enhancing user experience in mixed reality and augmented reality settings.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments and should in no way be construed so as to limit the claims.

Accordingly, it is to be understood that the above description is intended to be illustrative and not restrictive. Many embodiments and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

All terms used in the claims are intended to be given their broadest reasonable constructions and their ordinary meanings as understood by those knowledgeable in the technologies described herein unless an explicit indication to the contrary is made herein. In particular, use of the singular articles such as “a,” “the,” “said,” etc. should be read to recite one or more of the indicated elements unless a claim recites an explicit limitation to the contrary.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments incorporate more features than are expressly recited in each claim. Rather, as the following claims reflect, inventive subject matter lies in fewer than all features of a single disclosed embodiment. Thus, the following claims are hereby incorporated into the Detailed Description, with each claim standing on its own as a separately claimed subject matter.

While this disclosure includes references to illustrative embodiments, this specification is not intended to be construed in a limiting sense. Various modifications of the described embodiments, as well as other embodiments within the scope of the disclosure, which are apparent to persons skilled in the art to which the disclosure pertains are deemed to lie within the principle and scope of the disclosure, e.g., as expressed in the following claims.

Some embodiments may be implemented as circuit-based processes, including possible implementation on a single integrated circuit.

Some embodiments can be embodied in the form of methods and apparatuses for practicing those methods. Some embodiments can also be embodied in the form of program code recorded in tangible media, such as magnetic recording media, optical recording media, solid state memory, floppy diskettes, CD-ROMs, hard drives, or any other non-transitory machine-readable storage medium, wherein, when the program code is loaded into and executed by a machine, such as a computer, the machine becomes an apparatus for practicing the patented invention(s). Some embodiments can also be embodied in the form of program code, for example, stored in a non-transitory machine-readable storage medium including being loaded into and/or executed by a machine, wherein, when the program code is loaded into and executed by a machine, such as a computer or a processor, the machine becomes an apparatus for practicing the patented invention(s). When implemented on a general-purpose processor, the program code segments combine with the processor to provide a unique device that operates analogously to specific logic circuits.

Unless explicitly stated otherwise, each numerical value and range should be interpreted as being approximate as if the word “about” or “approximately” preceded the value or range.

The use of figure numbers and/or figure reference labels in the claims is intended to identify one or more possible embodiments of the claimed subject matter in order to facilitate the interpretation of the claims. Such use is not to be construed as necessarily limiting the scope of those claims to the embodiments shown in the corresponding figures.

Although the elements in the following method claims, if any, are recited in a particular sequence with corresponding labeling, unless the claim recitations otherwise imply a particular sequence for implementing some or all of those elements, those elements are not necessarily intended to be limited to being implemented in that particular sequence.

Reference herein to “one embodiment” or “an embodiment” means that a particular feature, structure, or characteristic described in connection with the embodiment can be included in at least one embodiment of the disclosure. The appearances of the phrase “in one embodiment” in various places in the specification are not necessarily all referring to the same embodiment, nor are separate or alternative embodiments necessarily mutually exclusive of other embodiments. The same applies to the term “implementation.”

Unless otherwise specified herein, the use of the ordinal adjectives “first,” “second,” “third,” etc., to refer to an object of a plurality of like objects merely indicates that different instances of such like objects are being referred to, and is not intended to imply that the like objects so referred-to have to be in a corresponding order or sequence, either temporally, spatially, in ranking, or in any other manner.

Unless otherwise specified herein, in addition to its plain meaning, the conjunction “if” may also or alternatively be construed to mean “when” or “upon” or “in response to determining” or “in response to detecting,” which construal may depend on the corresponding specific context. For example, the phrase “if it is determined” or “if [a stated condition] is detected” may be construed to mean “upon determining” or “in response to determining” or “upon detecting [the stated condition or event]” or “in response to detecting [the stated condition or event].”

Also, for purposes of this description, the terms “couple,” “coupling,” “coupled,” “connect,” “connecting,” or “connected” refer to any manner known in the art or later developed in which energy is allowed to be transferred between two or more elements, and the interposition of one or more additional elements is contemplated, although not required. Conversely, the terms “directly coupled,” “directly connected,” etc., imply the absence of such additional elements.

As used herein in reference to an element and a standard, the term compatible means that the element communicates with other elements in a manner wholly or partially specified by the standard and would be recognized by other elements as sufficiently capable of communicating with the other elements in the manner specified by the standard. The compatible element does not need to operate internally in a manner specified by the standard.

The functions of the various elements shown in the figures, including any functional blocks labeled as “processors” and/or “controllers,” may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (DSP) hardware, network processor, application specific integrated circuit (ASIC), field programmable gate array (FPGA), read only memory (ROM) for storing software, random access memory (RAM), and nonvolatile storage. Other hardware, conventional and/or custom, may also be included. Similarly, any switches shown in the figures are conceptual only. Their function may be carried out through the operation of program logic, through dedicated logic, through the interaction of program control and dedicated logic, or even manually, the particular technique being selectable by the implementer as more specifically understood from the context.

As used in this application, the terms “circuit,” “circuitry” may refer to one or more or all of the following: (a) hardware-only circuit implementations (such as implementations in only analog and/or digital circuitry); (b) combinations of hardware circuits and software, such as (as applicable): (i) a combination of analog and/or digital hardware circuit(s) with software/firmware and (ii) any portions of hardware processor(s) with software (including digital signal processor(s)), software, and memory (ies) that work together to cause an apparatus, such as a mobile phone or server, to perform various functions); and (c) hardware circuit(s) and or processor(s), such as a microprocessor(s) or a portion of a microprocessor(s), that requires software (e.g., firmware) for operation, but the software may not be present when it is not needed for operation.” This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

It should be appreciated by those of ordinary skill in the art that any block diagrams herein represent conceptual views of illustrative circuitry embodying the principles of the disclosure. Similarly, it will be appreciated that any flow charts, flow diagrams, state transition diagrams, pseudo code, and the like represent various processes which may be substantially represented in computer readable medium and so executed by a computer or processor, whether or not such computer or processor is explicitly shown.

As used herein in reference to an element and a standard, the term compatible means that the element communicates with other elements in a manner wholly or partially specified by the standard and would be recognized by other elements as sufficiently capable of communicating with the other elements in the manner specified by the standard. The compatible element does not need to operate internally in a manner specified by the standard.

What is claimed is:

1. A method for providing thermal haptic feedback in a virtual or augmented reality using a wearable device comprising a grid of thermoelectric modules, the method comprising:
obtaining virtual environment data describing a virtual object and material properties of the virtual object;
obtaining real-world thermal input data from a real-world environment;
calculating a temperature profile for the virtual object by simulating heat conduction using a plurality of contact points and the material properties, wherein the plurality of contact points are identified based on the virtual environment data;
processing the real-world thermal input data and the temperature profile to assign temperature setpoints to one or more thermoelectric modules in the grid of thermoelectric modules; and
generating thermal sensations by actuating the one or more thermoelectric modules.

2. The method of claim 1, wherein the real-world thermal input data is obtained from temperature sensors positioned on contact surfaces of the thermoelectric modules, and wherein processing the real-world thermal input data comprises selectively overriding the temperature setpoints when contact with a real-world object is detected.

3. The method of claim 1, wherein calculating the temperature profile comprises simulating heat transfer by determining heat absorption on a cold side of each thermoelectric module based on material properties, applied current, and temperature conditions.

4. The method of claim 1, wherein generating thermal sensations comprises creating spatial-temporal thermal patterns by sequentially actuating different thermoelectric modules in the grid to simulate movement of a thermal source across a user's palm.

5. The method of claim 1, further comprising maintaining the thermoelectric modules at a baseline temperature corresponding to skin temperature using a thermal management system, wherein the temperature setpoints represent deviations from the baseline temperature.

6. The method of claim 1, wherein the grid comprises a 3×3 array of thermoelectric modules, and wherein processing the real-world thermal input data and the temperature profile comprises mapping specific contact areas of the virtual object to corresponding spatial locations in the 3×3 array.

7. The method of claim 1, wherein the wearable device is mounted on user's palm with control hardware positioned on a back of a user's hand or forearm, and wherein the method further comprises maintaining user dexterity by allowing unrestricted finger movement during thermal feedback generation.

8. A thermal haptic feedback system for virtual or augmented reality applications, comprising:
a wearable device comprising a grid of thermoelectric modules;
a virtual environment interface configured to obtain virtual environment data describing a virtual object and material properties of the virtual object;
one or more thermal sensors configured to obtain real-world thermal input data from a real-world environment;
a processing unit configured to:
calculate a temperature profile for the virtual object by simulating heat conduction using a plurality of contact points and the material properties, wherein the plurality of contact points are identified based on the virtual environment data; and
process the real-world thermal input data and the temperature profile to assign temperature setpoints to one or more thermoelectric modules in the grid; and
a thermal control unit configured to generate thermal sensations by actuating the one or more thermoelectric modules according to the assigned temperature setpoints.

9. The system of claim 8, wherein the one or more thermal sensors comprise temperature sensors positioned on contact surfaces of the thermoelectric modules, and wherein the processing unit is configured to selectively override the temperature setpoints when the thermal sensors detect contact with a real-world object.

10. The system of claim 8, wherein the processing unit is configured to calculate the temperature profile by simulating heat transfer through determining heat absorption on a cold side of each thermoelectric module based on material properties, applied current, and temperature conditions, accounting for thermal conduction losses and electrical resistance heating effects.

11. The system of claim 8, wherein the thermal control unit is configured to create spatial-temporal thermal patterns by sequentially actuating different thermoelectric modules in the grid to simulate movement of a thermal source across a user's palm.

12. The system of claim 8, further comprising a thermal management system configured to maintain the thermoelectric modules at a baseline temperature corresponding to skin temperature, wherein the temperature setpoints represent deviations from the baseline temperature.

13. The system of claim 8, wherein the grid comprises a 3×3 array of thermoelectric modules, and wherein the processing unit is configured to map specific contact areas of the virtual object to corresponding spatial locations in the 3×3 array.

14. The system of claim 8, wherein the wearable device comprises a flexible base configured to be mounted on a user's palm, and control hardware positioned on a back of a user's hand or forearm, the wearable device being configured to maintain user dexterity by allowing unrestricted finger movement during thermal feedback generation.

15. An apparatus for simulating thermal haptic feedback in a virtual or augmented reality environment, the apparatus comprising:
an electronic processor; and
a memory storing instructions, the instructions when executed by the electronic processor, cause the apparatus to:
obtain virtual environment data describing a virtual object and material properties of the virtual object;
obtain real-world thermal input data from a real-world environment;
calculate a temperature profile for the virtual object by simulating heat conduction using a plurality of contact points and the material properties, wherein the plurality of contact points are identified based on the virtual environment data;
process the real-world thermal input data and the temperature profile to assign temperature setpoints to one or more thermoelectric modules in a grid of thermoelectric modules; and
generate thermal sensations by actuating the one or more thermoelectric modules.

16. The apparatus of claim 15, wherein the real-world thermal input data is obtained from temperature sensors positioned on contact surfaces of the thermoelectric modules, and wherein processing the real-world thermal input data comprises selectively overriding the temperature setpoints when contact with a real-world object is detected.

17. The apparatus of claim 15, wherein calculating the temperature profile comprises simulating heat transfer by determining heat absorption on a cold side of each thermoelectric module based on material properties, applied current, and temperature conditions.

18. The apparatus of claim 15, wherein generating thermal sensations comprises creating spatial-temporal thermal patterns by sequentially actuating different thermoelectric modules in the grid to simulate movement of a thermal source across a user's palm.

19. The apparatus of claim 15, wherein the instructions when executed by the electronic processor, further cause the apparatus to:
maintain the thermoelectric modules at a baseline temperature corresponding to skin temperature using a thermal management system, wherein the temperature setpoints represent deviations from the baseline temperature.

20. The apparatus of claim 15, wherein the apparatus is mounted on user's palm with control hardware positioned on a back of a user's hand or forearm, and wherein the instructions when executed by the electronic processor, further cause the apparatus to maintain user dexterity by allowing unrestricted finger movement during thermal feedback generation.
